(19) United States
(12) Patent Application Publication
(10) Pub. No.: US 2007/0198380 A1
(43) Pub. Date: Aug. 23, 2007

(54) Systems and methods for generating future revenue from a real property

(76) Inventor: Michael S. Hynek, Dallas, TX (US)

Correspondence Address: DOCKET CLERK, P.O. DRAWER 800889, DALLAS, TX, 75380, US

(21) Appl. No.: 11/634,821

(22) Filed: Dec. 6, 2006

Related U.S. Application Data
(60) Provisional application No. 60/742,819, filed on Dec. 6, 2005.
(60) Provisional application No. 60/742,591, filed on Dec. 6, 2005.

(51) Int. Cl. G06Q 40/00

(52) U.S. Cl. 705/35

(57) ABSTRACT

Systems and methods for generating future revenue from real property are provided. An example method includes (i) establishing a residual right associated with a real property and (ii) at a later time, determining whether a fee associated with the residual right is due. The establishing step may include (a) identifying at least one characteristic associated with the real property, where the at least one characteristic is capable of providing a benefit to the real property, and (b) reserving the residual right in the real property as a function of the at least one characteristic. The fee determination step may include (a) identifying a reservation of a residual right affecting the real property, where the residual right is associated with at least one characteristic capable of providing a benefit to the real property, and (b) determining whether the fee is payable as a function of the at least one characteristic.

### CROSS-REFERENCE TO RELATED APPLICATIONS

This application claims priority under 35 U.S.C. § 119(e) to U.S. Provisional Patent Application No. 60/742,819 filed on Dec. 6, 2005 and U.S. Provisional Patent Application No. 60/742,591 filed on Dec. 6, 2005, which are both hereby incorporated by reference.

This application is related to U.S. patent application Ser No. ______ [HYNE03-00003] entitled “SYSTEMS AND METHODS FOR FACILITATING REAL PROPERTY TRANSACTIONS” filed on Dec. 6, 2006, which is hereby incorporated by reference.

### TECHNICAL FIELD

This disclosure relates generally to generating future revenue from real property. More specifically, this disclosure relates to generating future revenue from real property using residual rights that are reserved in the real property.

### BACKGROUND

Owners of real property (such as raw land, improved land, residential properties, or commercial properties) often have certain limitations or encumbrances placed on their property. These limitations can take several forms. For example, an easement in a real property that is granted to a party typically provides that party with certain rights associated with the real property. Easements are often used to allow for the placement and maintenance of telephone, electric, and other utilities or other improvements or for the right of access or ingress over certain lands. Deed restrictions and municipal zoning laws and ordinances often restrict how an owner and future owners may develop or improve a real property. Deeds of trust and other legal documents typically secure an obligation of an owner of real property to make certain payments, granting a beneficiary certain rights to foreclose on the real property and/or take ownership of the real property in order to dispose of the obligation. Liens may also be used to secure payment of an obligation by an owner of real property, typically for work done on the property. Unlike deeds of trust, liens often do not allow for foreclosure, although exceptions are made in some areas for collecting property taxes or federal income taxes. There are many other types of encumbrances that can affect real property and, in most cases, an encumbrance is granted by an existing property owner for the benefit of at least one other party.

An attorney and/or a title company is typically charged with identifying the encumbrances that may affect a real property. Often times, the attorney or title company will conduct a search of real property records maintained by a county (in the United States) or other appropriate political subdivision in a particular geographic area. Upon a transfer of a real property from one owner to another, various legal documents are required to perfect the transfer of ownership and are recorded.

Typically, only a current owner or an entity that a current owner is obligated to may encumber a real property. Once an encumbrance is established on a real property, it may last in perpetuity or until the satisfaction of an obligation, the occurrence of an event, or the lapsing of a period of time. Upon a transfer of ownership of a real property, any encumbrance that lasts into perpetuity or that has not been extinguished at or before the transfer will remain as an encumbrance to the real property for any successive owner(s).

Millions of real property transfers occur every year in the United States and around the world. These real property transfers include sales, leases, or rentals of raw land, improved land, residential properties, or commercial properties. These transfers generally involve various parties, such as a seller who is selling a real property, a purchaser who is buying the real property, a landlord who leases or rents a real property, or a tenant who is the lessee or renter of the real property. P Optionally, one or more agents could also be involved in a property transfer, such as when real estate agents help an owner sell a real property or a buyer purchase a real property.

Oftentimes, owners of real property and real estate agents benefit when the real property is sold or when other transfers occur. For example, the owner of a real property may benefit financially if the property sells at a higher price than the owner originally paid for the property. Also, an owner of real property may benefit from the sale of the property because the sale proceeds are usually much more liquid than the real property. A real estate agent typically benefits when a real property is sold because the agent often charges a fee based upon a percentage of the sales price for the real property.

While current owners of real property and real estate agents may benefit when the real property is sold or when other transfers occur, other parties who may have previously owned or provided a benefit to the real property or who have otherwise previously been associated with the real property are often not compensated. The following represents examples of how a party may provide a benefit to real property or otherwise be associated with the real property and not receive any compensation for that benefit or association.

As a first example, a reputable entity (such as a reputable builder or developer) could spend many years and invest considerable resources and capital to establish a successful reputation. The reputable entity's association with a real property may help to increase the value, appreciation potential, or marketability of the real property into the future. The reputable entity may also provide prestige and pride to owners and other parties associated with the real property. A current owner of the real property or a real estate agent could exploit this association to sell the real property more quickly or at a higher price. While this benefits the current owner and any real estate agent (and possibly future owners or agents), the reputable entity typically does not benefit from the increased value, appreciation potential, or marketability of the real property enjoyed by these other parties.

As a second example, a party (such as a developer or prior owner) may perform one or several actions that benefit a real property for years to come (if not into perpetuity). The actions could include marketing and promoting a development in which the real property lies, establishing controls such as deed restrictions in the development, providing amenities or improvements in the development, or procuring certain entitlements or rights for the property or the development. These actions could help to maintain property values of real properties in the development, improve the reputation of the development, or increase the name recognition of the development, which may increase the value, appreciation potential, marketability, or prestige of ownership of the real property. Any of these benefits may be helpful to the current owner, any real estate agents, and possibly future owners and agents of the real property. However, the party or parties responsible for these benefits typically receive no compensation for the benefits enjoyed by the current or future owners or agents of the real property.

As a third example, a party (such as a developer or builder) may initially sell developed properties in a development at reduced sales prices to attract buyers and generate sales momentum when a development begins. Later, other developed properties in the development may be sold at higher prices, or new amenities or improvements may be installed in the development. The subsequent sales or new amenities or improvements could help to increase the values of the earlier sold properties. However, the party responsible for the benefits provided by the higher-priced subsequent sales or new amenities or improvements is typically not compensated for the increases in value of the earlier sold properties.

As a fourth example, a party (such as a current owner) may entitle, remodel, renovate, or make improvements to a development, building, or other types of real property that enhances the marketability of the real property. The enhanced marketability could benefit some or all future owners and agents of the real property. The party responsible for providing the enhanced marketability may recognize an increased sales price when that party sells the real property. However, the party may not be able to recognize the full value of the enhancements and is typically not able to generate future revenue associated with the enhanced marketability after the sale.

As a fifth example, a party (such as a current owner or developer) associated with a commercial shopping center or other shared development may lease, sell, or buy any portion of space in the development to or for a “blockbuster” or “anchor” tenant that brings in large amounts of customer traffic to the development. This increase in customer traffic often enhances the value or marketability of the development itself as well as other lease space in the development. However, the party that is responsible for the presence of the blockbuster tenant and the blockbuster tenant itself are typically not compensated for these benefits brought about by the continued presence of the blockbuster tenant after a sale of the shopping center or any portion thereof.

As a sixth example, an owner of a commercial property may lease space in the commercial property to one or multiple parties. One of the parties may have a lease that expires soon (such as within a year) when the owner sells or is trying to sell the commercial property. The party may be reluctant to renew or extend the lease prior to a sale. The owner typically receives a reduced price upon the sale of the commercial property because of the uncertainty as to whether the party will renew or extend its lease. However, even if the party does renew or extend its lease after the sale, perhaps based upon the efforts of the now prior owner, the prior owner typically receives no compensation for this renewal or extension.

As a seventh example, a party (such as a current owner, builder, developer, or consultant) may own, develop, or design a development that includes or is otherwise enhanced by a natural amenity or a manmade improvement that could be considered desirable. This party is typically not able to generate future revenue associated with the benefit of enhanced marketability, appreciation potential, or pleasure of ownership provided to future property owners after a property in the development is sold or a consulting fee is paid. Examples of these situations could include, but are not limited to, lakefront (natural and manmade), riverfront, ocean side, wooded, scenic, mountain resort, golf course community, and ski-in/ski-out community properties.

As an eighth example, a party (such as a current owner) may be unsure of the true value of a real property. As a particular example, the occurrence or timing of some event may be uncertain, but the event might significantly enhance the value of the property if or when it occurs. Typically, the current owner of the property cannot profit from any increased value or future benefit enjoyed by a future owner of the property if or when the event occurs after the property is sold. Examples of these situations could include, but are not limited to, the planning of a major improvement such as a highway, airport, stadium, mall, or other large scale development; rezoning, special use permits, or re-platting opportunities with a municipality; bond, wet/dry, and special district elections; or situations where the real property is transferred under the power of eminent domain.

As a ninth example, a party (such as a consultant, developer, builder, or owner) may be involved with, design, develop, or own a property that could be selected in the future for an award or to host a special event (i.e. PGA Tour event, Super Bowl, or College Bowl game). The benefit to the current owner could be an enhanced marketing appeal of the property, an increased market value, or other benefit. Typically, other parties who have been associated with the property are prevented from realizing a direct financial benefit associated with the award or selection to host the special event.

As a tenth example, a private or public district, a city, a school district, or another political subdivision could enhance the value, appreciation potential, or marketability of a real property in the political subdivision over and above its obligations to serve the property. For example, the political subdivision could possess or create a good reputation, or the political subdivision could possess or create certain services, amenities, or improvements that are highly desirable. As a specific example, a school district might need to decide where and/or how to build an elementary school. Typically, elementary schools in residential neighborhoods are considered highly desirable. While the presence of an elementary school could significantly enhance the marketability, appreciation potential, or value of properties in a neighborhood, the school district typically does not benefit financially from this.

As an eleventh example, a party (such as a current owner) may recognize that his or her property has or might have the potential to offer some kind of benefit, such as increased appreciation potential, increased marketability, or other benefit. The owner may have paid a premium to the actual real value of the property, and the owner may be unable to recoup that premium upon a sale of the property. An owner that recognizes an existing or potential benefit to his or her property typically has not been able to generate future revenue associated with that benefit after the property is sold.

As a twelfth example, the purchase of a real property can be speculative, and the risks associated with purchasing and owning real property can be significant. An owner, who assumes all of the risks associated with real property ownership, may not recognize the full value of his or her investment because he or she does not have a mechanism to generate revenue after the property is sold.

As shown in these examples, a party that creates, provides, finds, establishes, or identifies a benefit to real property or is otherwise associated with a real property that has certain benefits often has not taken the necessary action to generate revenue commensurate with the benefit to the real property upon future sale(s) of real property. This party therefore has been unable to realize income from the real property once the property is sold or a service has been provided.

In fact, very few mechanisms have been used by real property owners to generate revenue after a property is sold. One mechanism allows a prior landowner to retain mineral rights in a real property. The prior landowner, with such a mineral interest separated from the remainder of the real property ownership, may receive compensation if saleable minerals are extracted from the property. This mechanism involves the prior landowner actually retaining title to a portion of the real property (the mineral estate), and the prior landowner is permitted to enjoy use of that portion of the real property.

Other mechanisms provide for a seller of a real property to provide financing to a buyer of the property. The seller, using a mechanism such as a mortgage or contract of sale, may collect principle and interest payments associated with a loan. In these mechanisms, title to the real property (contract of sale) or an interest in the title to the property (mortgage) remains with the seller until the payments are completed.

Another mechanism allows a property owners' association (“POA”), management company, or non-profit entity set up to benefit a real property to collect revenue for the purposes established by that entity. The entity may use covenants running with the land, often referred to as deed restrictions or restrictive covenants, to require periodic payments from a current owner of the property and, in most cases, the payments are intended to cover expenses of the entity. Using such a mechanism, the POA or other entity often has no interest in the real property, and the only enforcement mechanism available for breach of the covenant is enforcement under contract law (such as litigation to enforce the covenants).

Yet another mechanism allows a previous landowner or developer to receive a reimbursement for improvements made to or for a particular property, such as reimbursements made under an agreement with other property owners, a municipality, a municipal utility district, any other special district, any other political subdivision, or some combination of these entities. Like the POA example, the only enforcement mechanism typically available for breach of the agreement is enforcement under contract law (such as litigation to enforce the obligation).

A final mechanism allows a previous owner or other party to obtain a net profits interest in the property. In most cases, a net profits interest allows the beneficiary to receive proceeds based solely upon the profit, if any, derived by a certain entity that is generated through the real property. Again, the only enforcement mechanism typically available for breach of the net profits agreement is enforcement under contract law (such as litigation to enforce the obligation).

In all of the foregoing mechanisms, there typically exists at least one of four qualities. The first quality is the mechanism requires a separation or division of the real property such that title to at least a portion of the real property remains with the previous owner. The second quality is that the mechanism involves some form of monetary contribution from a beneficiary towards the real property either directly (such as in the case of a reimbursement) or indirectly (such as in the case of a seller financing). The third quality is that the mechanism is only intended to either provide for anticipated costs (such as in the case of a non-profit entity, management company, or POA) or for the distribution of any profits over some defined period (such as in the case of a net profits interest). The fourth quality is that the enforcement of the obligation to pay the future revenue is tied to an agreement, mortgage, or contract and may only be upheld through contract law and/or litigation.

None of the foregoing mechanisms has typically been used to generate revenue for developers, builders, consultants, prior owners, or other parties for perpetual and incremental increases in value, ongoing appreciation potential, enhanced marketability, or extraordinary pleasure, pride, or prestige of ownership, use, or association with a real property that occurs after a real property is sold or a service has been provided. None of the foregoing mechanisms typically provides for a perpetual revenue stream with no separation or division of the real property; no direct or indirect additional monetary contribution; no profit, budget, or cost calculation, estimation, or determination; or that is based solely upon a specific, defined, tangible, and/or measurable event.

### SUMMARY

To address the above-discussed deficiencies of the prior art, this patent document broadly discloses systems and methods for generating future revenue from real property based upon a real property owner's ability to reserve (either for itself or for another party) a residual right in the real property. A beneficiary of the residual right could, for example, represent the owner of the real property or a person or entity designated by the owner of the real property. A residual right may represent a reservation of an interest in a real property that provides a right to future revenue, without any right to use or otherwise enjoy the real property with which the residual right is associated. Accordingly, residual rights may be recordable as an interest in real property and enforceable using typical real property ownership rights enforcement mechanisms and techniques.

According to one example embodiment, (i) a residual right associated with a real property is established, and (ii) at a later point in time, it is determined whether a fee associated with the real property is due. By way of example, the step of determining whether a fee is due may be performed by a title company at or about the time that the real property is transferred to another party, is refinanced, or some other event occurs. Also, an amount of the fee may or may not be calculated independently and without correlation to any characteristic of the real property.

In particular embodiments, the step of establishing the residual right could include the steps of (i) identifying at least one characteristic associated with the real property, where the at least one characteristic is capable of providing a benefit to the real property, and (ii) reserving the residual right in the real property as a function of the at least one characteristic (while the remainder of an owner's ownership rights in the real property are conveyed). The owner may then receive payment for the benefit associated with the at least one characteristic. The at least one characteristic may or may not be specifically identified in a reservation of the residual right.

In particular embodiments, the step of determining whether a fee is due could include the steps of (i) identifying the reservation of a residual right affecting the real property, where the residual right is associated with at least one characteristic that is capable of providing a benefit to the real property, and (ii) determining whether the fee is due and payable and an amount of the fee as a function of the at least one characteristic. The determination of whether the fee is payable may be established solely in the reservation of the residual right.

According to another embodiment, a system includes a memory capable of storing information identifying a real property. The system also includes a processor capable of retrieving data records associated with the real property. The data records include information identifying a reservation affecting the real property. The reservation establishes a residual right associated with the real property. The residual right is associated with at least one characteristic that is capable of providing a benefit to the real property. The information associated with the reservation allows a determination as to whether a fee associated with the reservation is payable, how much the fee is, who pays the fee, and/or to whom the fee is payable.

In a related embodiment, a computer program is embodied on a computer readable medium and is operable to be executed by a processor. The computer program includes computer readable program code for (i) retrieving one or more recorded exceptions to title associated with an identified real property, the one or more recorded exceptions identifying a reservation associated with the real property, the reservation establishing a residual right affecting the real property, the residual right associated with at least one characteristic that is capable of providing a benefit to the real property, and (ii) providing the recorded exceptions to a user for use in calculating, collecting, and/or disbursing a fee associated with the reservation.

It should be noted that various aspects of these or other embodiments may be implemented or executed by one party or several parties. For instance, establishing a residual right associated with a real property may be performed by or on behalf of a current property owner, a real estate investor, a real estate developer, a builder, a political subdivision, a professional golfer, an architect, or any other party associated with or affecting the real property. Because residual rights include a reservation of an interest in a real property, a property owner may make the reservation. The property owner may, however, make such a reservation on his or her own behalf or on behalf of another and thus provide the benefit of the residual rights to other individuals or entities. For example, a developer may contract with a famous golfer to design a golf course in a development. The famous golfer may believe that a golf course he or she develops is likely to add to the rate at which the lots in the development are sold or appreciate. The famous golfer may contract with the developer to have the developer reserve residual rights in each lot sold and provide those rights to the famous golfer as full or partial payment for this valuable feature of the development.

According to yet another embodiment, establishment of a residual right in a real property may include (i) identifying at least one characteristic associated with the real property, where the at least one characteristic is capable of providing a future benefit to the real property, and (ii) reserving the residual right in the real property as a function of the at least one characteristic. The at least one characteristic may or may not be specifically identified in a reservation of the residual right.

In a related embodiment, a determination of whether a fee associated with a real property is due may include (i) identifying a reservation of a residual right affecting the real property, where the residual right is associated with at least one characteristic that is capable of benefiting the real property, and (ii) determining whether the fee is payable as a function of the at least one characteristic. The determination of whether the fee is payable may be established solely in the reservation of the residual right.

In another related embodiment, reservation of a residual right in a real property may entitle a party associated with the residual right to receive revenue based on a future benefit received by at least one of the real property and an owner (past, current, or future) of the real property. At some later time after the residual right is established, determination of whether a fee associated with the residual right is due and payable is based on the benefit received by the real property or an owner of the real property.

According to still another example embodiment, a residual right associated with a real property is established. At a later time, revenue associated with the residual right is received.

Reservation of a residual right in a real property may entitle a party associated with the residual right to receive revenue based on existing, future, or potential benefits received by at least one of the real property, an owner (past, current, or future), or a tenant (past, current, or future) of the real property. At some later time after the residual right is established, the determination of whether a fee associated with the residual right is due and payable may be based on the benefit received by the real property or an owner or tenant of the real property.

The foregoing has outlined rather broadly the features and technical advantages of the present invention so that those skilled in the art may better understand the DETAILED DESCRIPTION OF EXAMPLE EMBODIMENTS that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form. For example, combining the concept of using residual rights in real property to generate future revenue with other mechanisms used to generate future revenue from real property or the right to use and enjoy a real property should not take away from the present invention.

Before undertaking the DETAILED DESCRIPTION OF EXAMPLE EMBODIMENTS below, it may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, including, be included within, interconnect with, contain, containing, be contained within, connect to or with, have some correlation with, couple to or with, be communicable with, cooperate with, interleave, juxtapose, be proximate to, be bound to or with, have, have a property of, or the like. The terms “processor” and “controller” mean any device, system, or part thereof that controls at least one operation and may be implemented in hardware, firmware, software, or some combination of at least two of the same. It should be noted that the functionality associated with any particular processor or controller may be centralized or distributed, whether locally or remotely. The phrase “function of” may mean based upon, as a result of, because of, dependent on, or the like. Definitions for other words and phrases are provided throughout this patent document, and those of ordinary skill in the art should understand that these definitions apply to prior as well as future uses of such defined words and phrases.

### BRIEF DESCRIPTION OF DRAWINGS

For a more complete understanding of this disclosure, reference is now made to the following description, taken in conjunction with the accompanying drawings, in which:

FIG. 1 illustrates an example property development according to one embodiment of this disclosure;

FIG. 2 illustrates another example property development according to one embodiment of this disclosure;

FIG. 3 illustrates an example system for identifying residual rights used for generating revenue from real property according to one embodiment of this disclosure;

FIG. 4 illustrates an example method for identifying residual rights used for generating revenue from real property according to one embodiment of this disclosure; and

FIG. 5 illustrates an example method for reserving a residual right associated with a property according to one embodiment of this disclosure.

### DETAILED DESCRIPTION OF EXAMPLE EMBODIMENTS

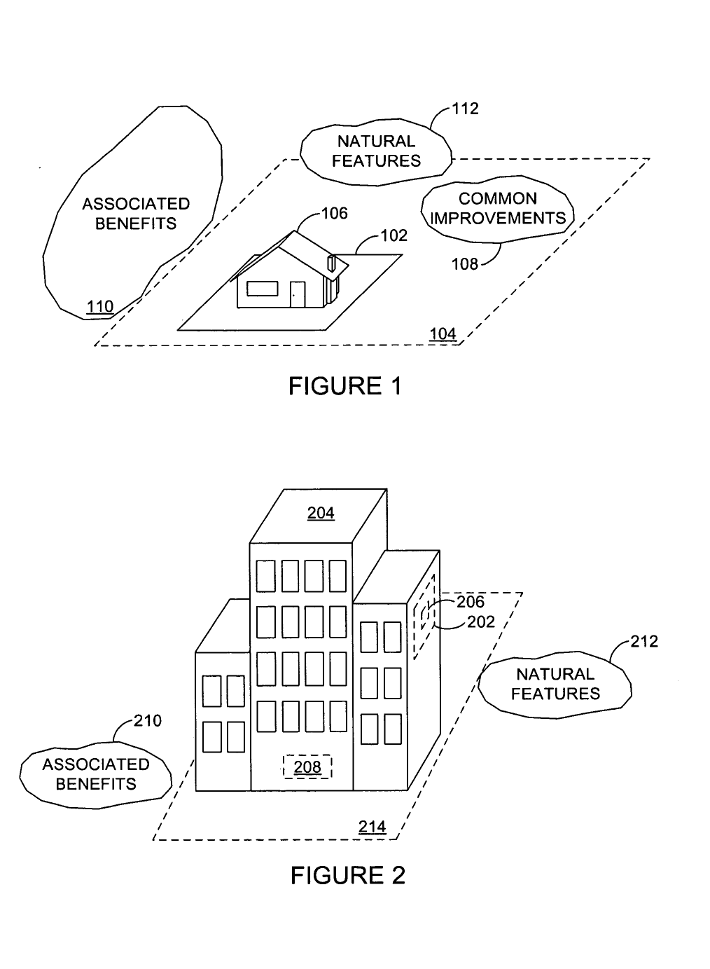

FIG. 1 illustrates an example property development according to one embodiment of this disclosure. The property development shown in FIG. 1 is for illustration only. Other property developments may be used without departing from the scope of this disclosure.

As shown in FIG. 1, a property 102 is contained within a development 104. The property 102 represents any amount or portion of land or real property. For example, the property 102 may represent a “lot” within a residential or commercial subdivision. The property 102 could represent any residential, commercial, or other type of property. In this document, the phrase “real property” refers to property such as land, that which is incidental or appurtenant to land (such as a structure), that which is immovable by law, or any combination thereof.

One or more people or entities may have any suitable right to or interest in the property 102. As examples, a property 102 could be owned and used by one or more people or entities, owned by one person or entity and rented or leased to another, or owned by multiple people or entities as a timeshare or fractional ownership. In this document, the terms “right” and “interest” (as in a right to or an interest in a property 102) refer to any legal entitlement associated with part or all of a property, such as the right to occupy a property or part thereof.

The development 104 represents a collection of properties 102. The development 104 may include any number or type of properties 102, and the properties 102 may be arranged in the development 104 in any suitable manner. As examples, the development 104 could represent a commercial development containing only commercial properties 102, a residential development containing only residential properties 102, or a development containing both residential and commercial properties 102.

In this example, the property 102 represents a residential property containing an improvement 106. In this document, the term “improvement” refers to anything done to a property that enhances the value, desirability, or usability of the property. In this example, the improvement 106 represents a house built on the property 102. While a house is shown in FIG. 1 as an improvement 106 to the property 102, any other or additional improvements 106 could be made to the property 102. Other improvements could include, without limitation, other types of structures; excavation (cut and fill); clearing; grading; water, drainage, and sewer systems; electrical transmission systems; Internet, television, and telephone transmission systems; landscaping, entitlements, platting, and deed restrictions.

As shown in the illustrated embodiment, the development 104 includes one or more common improvements 108. Also, the development 104 is affected by one or more associated benefits 110. The common improvements 108 represent improvements made to land within or associated with the development 104 or benefits or rights granted to people having interests in properties 102 within the development 104. As examples, the common improvements 108 could represent amenities such as membership in a property owner's association; rights to use community swimming pools, clubhouses, tennis courts, playgrounds, or parks; or any other or additional amenities or benefits in the development 104. The common improvements 108 often are not specific to a particular property 102.

Similarly, the associated benefits 110 represent improvements made to or benefits of areas associated with the development 104. The areas associated with the development 104 could represent areas near or adjacent to the development 104. As examples, the associated benefits 110 could represent golf courses or manmade lakes. The associated benefits 110 could also represent a proximity to schools, museums, bus or train routes, or other services or amenities. The associated benefits 110 could further include any other or additional amenities or benefits. The common improvements 108 and the associated benefits 110 may be positioned in any suitable manner. As examples, some or all common improvements 108 and associated benefits 110 could be located within the development 104 or outside of the development 104.

In addition, one or more natural features 112 may be associated with the development 104. For example, the natural features 112 could lie within the development 104, lie near or adjacent to the development 104, surround the development 104, or be visible from the development 104 or a portion thereof. As examples, the natural features 112 could represent creeks, streams, lakes, ponds, oceans, or other waterways or bodies of water. The natural features 112 could also represent hills, valleys, mountains, forests, or any other natural feature.

Many different parties or entities may be associated with a property 102 in one way or another. For example, a property 102 may have one or more current owners and one or more prior owners. An improvement 106 on the property 102 may be associated with an architect, landscaper, contractor, designer, builder, or any other professional or celebrity. The development 104 in which the property 102 is located may be associated with a prior landowner, current landowner, developer, land planner, engineer, designer, or any other professional or celebrity. A common improvement 108 or an associated benefit 110 may be associated with an architect, designer, builder, developer, golfer, or some other professional or celebrity. In addition, the property 102, development 104, common improvement 108, or associated benefit 110 could be associated with a reputable neighborhood, private district, city, school district, special district (such as a historical district, special taxing district, free enterprise district, or environmental district), or other categorical, relational, and/or political subdivision (collectively referred to as an identified subdivision).

Any of the parties and entities mentioned above may provide and/or recognize certain benefits to or associated with the property 102, the development 104 in general, the common improvements 108, or the associated benefits 110. For example, these parties and entities may perform actions that increase, or in the future may increase, the value, appreciation potential, marketability, or pleasure, pride, or prestige of ownership, use, or association therewith of the property 102. However, under prior approaches, typically only the subsequent owners of the property 102 and any agents hired by the subsequent owners benefited financially from these benefits. The other parties and entities mentioned above may not have been compensated fully for the benefits they provided to the property 102 or development 104, but rather are limited to any profits made in the sale of the property 102 (in the case of an owner, developer, or builder) or the fee charged for a service (in the case of a consultant, architect, or designer). The full value of benefits added or identified by a party may not be appreciated by others until after such a party has transferred ownership and the associated rights of ownership in the real property. Thus, the party is unable to extract payment for the benefits at the time such a party conveys the real property.

As an example, a developer or prior owner often did not benefit financially when the value of a property increased after the developer or prior owner sold the property. As another example, an architect, designer, or other consultant often did not benefit financially when the value of the property increased after the consultant performed a service and received a fee for that service. This is true even if the developer, prior owner, or consultant added or recognized a benefit such as future appreciation potential, increased marketability, or enhanced pleasure, pride, or prestige of ownership, use, or association therewith of the property 102.

In accordance with this disclosure, a developer, builder, owner, consultant, or any other suitable party or entity is provided with a new mechanism for generating revenue associated with a property 102. In particular, the developer, builder, owner, consultant, or other party or entity may retain or receive a residual right in a property 102. The residual right allows the party or entity to receive a fee or other form of revenue, even after the party or entity has sold the property 102 or performed a service and been paid for that service. Among other things, residual rights allow parties and entities that provide a benefit to a property 102 to be compensated, or more fully compensated, for that benefit.

In this document, the phrase “residual right” refers to a right associated with a real property that is retained or granted to an individual or entity for the purpose of generating future revenue without any right to use or otherwise enjoy the real property with which the residual right is associated. A residual right is a retained interest in the real property and may be held by the owner of real property reserving the right or granted to another individual or entity. Rights to future revenue provided by residual rights may provide payment of such revenue to a holder of the residual rights or to another individual or entity. Residual rights may be recordable as an interest in real property and enforceable using typical real property ownership rights enforcement mechanisms and techniques. A real property may be subject to one or multiple reservations of a residual right.

“Revenue” as may be provided by residual rights includes income, profits, compensation, or other monetary or financial reward as may be set forth in or established by the residual rights. However, “revenue” as provided by residual rights does not include proceeds for payments associated with mineral interests, payments associated with seller-financed purchases of a property, or payments associated with POAs, non-profit entities, or management companies (such as expense-related items). The term “revenue” as used with respect to residual rights also does not include proceeds for reimbursements of expenses associated with the design, construction, installation, management, or financing of improvements that are reimbursed by a property-tax collecting entity or other identified subdivision or through a lien on any property and where a reservation of a residual right is not used.

A residual right associated with a property 102 could establish any type of fee or other form of revenue. For example, the residual right could specify a fixed fee that remains constant or is specific during certain time intervals. The fee could also be variable, such as a fee that increases each year by a specified percentage or a fee that is based on an appraised value, a value assessed by a taxing authority, or a sale price of the property. The fee could also represent a percentage of an increased value or selling price of a property 102, such as when the fee equals some percentage of the difference between a prior selling price and a current selling price. In addition, the fee could represent a percentage of a month's rent for a property 102 or, in the case of a property transfer, a percentage of an agent's fee to market the property 102. The fee could be determined using any other method or any combination of methods. The fee may be associated with a value of a benefit to real property, where the benefit is created, provided, established, identified, or otherwise associated with the real property by an owner of the real property. This may provide such an owner or an owner's designee with the ability to generate revenue commensurate with the benefit to the real property 102 after the property 102 is sold or a service has been provided.

The residual right associated with a property 102 could also be established in any suitable manner. In general, the residual right may be created by any person or entity with the power to reserve or grant rights in a property 102. For example, the residual right may be established in any deed transferring a property, such as a deed initially transferring a property 102 from a developer to a homebuilder or upon any subsequent transfer of the property 102. The residual right could also be created in a separate reservation document established against any property 102 or in an ownership certificate or any other transfer document. The residual right could further be specified in another document within the sequence or “chain” of title documents associated with a property. In this document, the phrase “title document” refers to any document affecting ownership rights or other rights to a real property or portion thereof. The document establishing the residual right could be filed or recorded by, or on behalf of, any party in the chain of title for the property.

An obligation to pay the fee associated with a residual right could be triggered in any suitable manner. For example, the fee could be owed to a party or entity in response to certain events. The events could include one, some, or all transfers of an interest in the property 102 (such as a sale, lease, or rental), payment of property taxes for the property 102, a time interval (such as a year) elapsing, or a foreclosure of the property 102. The events could also include a finance or refinance of the property 102, the researching of the title for a property 102, a release of an encumbrance (such as a lien or deed of trust) affecting the property 102, a renewal of a lease or rental agreement affecting the property 102 or some portion thereof, or the occurrence of some event (such as a golf course associated with a development 104 hosting a PGA Tour event). Any other event or combination of events, whether or not it is associated with the property 102 or development 104, could trigger the obligation to pay the fee associated with a residual right. Also, the obligation to pay the fee could be unlimited or limited to a number of transactions or a length of time, such as when the fee is owed in response to each of the first five sales of the property or when the fee is owed five years after a certain event and then is due each year thereafter.

When the obligation to pay the fee is triggered by a transfer of interest involving a property 102, the fee may be owed even if the party or entity to whom the fee is owed is not involved in the transfer. For example, the fee may be owed to the developer of a development 104 for any transfer involving a property 102 in the development 104, including transfers that take place after the developer sells the property 102 to an initial buyer. As another example, a property owner may establish a residual right that does not require a fee to be paid upon his or her sale of the property 102 but requires a fee to be paid on all subsequent sales of property 102. Because of this, a party or entity may receive revenue long after a property 102 has been sold or a service has been provided and payment for the service received.

The residual right for a property 102 may or may not have conditions defining when the fee is owed to a party or entity associated with the residual right. For example, the fee may be owed only if the value of a property 102 has increased or the property 102 receives another tangible or intangible benefit because of some identifiable characteristic associated with the residual right. The residual right or the obligation to pay the fee is therefore a function of the benefit provided by the identifiable characteristic. The identifiable characteristic may represent any feature or aspect of the property 102 or development 104 that may benefit the property and may or may not be specifically referenced in the reservation of the residual right. The identifiable characteristic could represent, for example, the reputation of a builder, designer, architect, or other consultant associated with the property 102, development 104, improvement 106, common improvement 108, amenity, or associated benefit 110 (or combination thereof). Also, the fee associated with a residual right could be owed as long as a particular person or entity is associated in some way with the property 102 or development 104 or with an area near, adjacent to, or otherwise associated with the property 102 or development 104. As an example, the fee associated with a resort property could be owed on timeshares, fractional ownerships, or other properties as long as a reputable entity's name (such as Ritz Carlton or Four Seasons) is associated with the property. Further, the fee could be owed as long as a property 102 increases in value or otherwise receives some minimum benefit. In addition, as examples, the fee could be determined as a percentage of the increased sales price or appraised value established for a taxing entity. The residual right may or may not establish thresholds based upon a specified percentage or amount that a property's value must increase before the fee is due. In other examples, the residual right may establish a fee or other form of revenue without any underlying conditions.

Although a residual right may be associated with one or more identifiable characteristics, language identifying the identifiable characteristic(s) does not need to be specified or otherwise identified in the reservation of the residual right. For example, a master planned community could include various locations for schools and a professionally designed golf course, but reservations of residual rights for properties in the community need not specifically identify these characteristics as forming the basis of the residual rights. However, particular embodiments may include detailed information within the document.

Beyond that, once established, a residual right is transferable from one party to another. For example, a developer could establish a residual right in a property 102 and then transfer the right to another party, such as a company organized to collect residual right fees. A residual right may be transferred in any suitable manner, including through written contracts and other agreements.

In addition, a party may establish a residual right in order to ensure enforceability of the residual right under applicable law (such as the law of the jurisdiction in which the real property is disposed). For example, the party may clearly set forth the amount of any fee, any basis for calculating fees, the triggering event(s) upon which such fees become due and payable, the person or persons to whom such fees are payable, the duration of the residual right, any limiting or terminating characteristics of the residual right, and/or the like.

A residual right may also limit or prevent future owners of the property 102 from reserving another residual right. For example, a developer could reserve a residual right in a property 102 and prevent future owners from doing so (even if the developer did not reserve a residual right for itself or another party). In this way, the developer may help to prevent other parties from reserving excessive residual rights in the property 102, which could cause the value of the property 102 to fall or otherwise harm future owners of the property 102. A party establishing a residual right may additionally or alternatively establish that the residual right is subordinate to other interests in the property 102, such as when the party indicates that the residual right is subordinate to a primary or other mortgage or other type of financing.

A party establishing a residual right could also establish a “ceiling” or a “floor” amount for fees associated with that residual right or associated with all subsequent residual rights, such as when the fee will not be less than “X” or greater than “Y” (where X and Y may be fixed or variable values). A party establishing a residual right could also establish a buyout provision or other termination provisions for the residual right.

Once established, a residual right may be transferable from one party to another. For example, a developer could establish a residual right in a property 102 and then transfer the right to another party. Residual rights may be transferred in any suitable manner, including through written contracts and other agreements.

The following represents several specific examples of how a party or entity may use a residual right to receive revenue associated with a property 102. These are non-limiting examples provided for illustration only. The residual rights could be used in any other suitable situation to generate revenue associated with one or more properties 102.

As a first example, a developer of a development 104 may be highly regarded such that the developer's name provides value or a positive influence to prospective purchasers of a property 102. The developer is therefore said to be a “reputable entity.” In general, a “reputable entity” may represent any party having a reputation that provides or that could be considered to provide some benefit to a real property (such as good workmanship, product quality, or warranty that could eventually yield increased value, appreciation potential, or marketability) or to an owner or user of a real property (such as increased pride or prestige). Also, the developer may successfully market a development 104 (such as a master planned community), increasing the name recognition of the development 104 itself. The developer could further establish controls (such as deed restrictions), install amenities or improvements (such as common improvements 108) in the development 104, or successfully incorporate various natural features 112 into the design of the development 104. The controls, amenities, improvements, and natural features could be installed or incorporated before or after the property 102 is sold by the developer. In addition, the development 104 may earn a reputation as a highly desirable neighborhood to live in, as well as providing pride or prestige to those owning properties in the development 104.

Through these or other actions, the value of the property 102 may increase, or the property 102 may benefit in some other way (such as improved marketability). Previously, the developer typically generated revenue only by selling properties in the development 104. The developer did not profit when the property 102 benefited from the developer's actions after the developer sold the property 102.

By allowing the developer to reserve a residual right in the property 102, the developer could, for example, receive a fee each time the property 102 was sold. The residual right may establish that the developer is entitled to a fee in association with particular transfers of the property, such as a second or all subsequent transfer(s) so as to avoid a builder having to pay the fee. This allows the developer to generate revenue from the property 102 even after the developer sells the property 102 to an initial buyer. This may also allow the developer to regain revenue lost if the developer initially sold the property 102 for a price lower than the expected market value, which may have been done to attract buyers during the early stages of the development 104. This may further allow the developer to recapture the developer's expenditures for amenities, improvements, or natural features installed or incorporated after the developer sold the property 102.

As a second example, a designer may design a feature associated in some way with a property 102. For example, the designer may design an improvement 106 on the property 102 or a common improvement 108 in the development 104. The designer may also design the development 104 itself, such as by designing the development 104 to incorporate several natural features 112. Also, the designer may gain some form of recognition, whether or not that recognition relates to the design associated with the property 102. The designer's design and increased recognition may help to increase the value of the property 102 or provide another benefit to the property 102.

If the designer is provided a residual right in the property 102 (such as through a current owner of the property reserving a residual right and transferring the benefits of such right to the designer or reserving a residual right and identifying the designer as the beneficiary of fees associated with the residual right), the designer may profit from the benefits provided to the property 102, even after the designer has completed the design and been paid for that design. This may also allow the designer to specify an alternative way of getting paid for a design. Rather than getting paid a flat fee for a design, the designer could be paid a lower or no up-front fee and collect revenue based on the future benefits received by the property 102.

As a third example, a land speculator or land owner may assemble a group of properties or successfully manage to keep a group of properties together and may entitle the properties, maintain the properties, or improve the properties in such a way as to create some benefit to the properties. The land speculator may then sell or transfer the rights to purchase the properties, or the owner may then sell the properties. At a later date, the properties may increase in value or receive some other benefit because of the actions of the land speculator or owner. This benefit may not have been recognized when the land speculator or owner sold the properties, so the land speculator or owner may have received a lower price for the properties. By allowing the land speculator or prior owner to reserve the residual right, the land speculator or prior owner is provided with a mechanism for generating revenue based on the future increase in the value of the properties or other benefit to the properties. This revenue may be generated even after the land speculator sold or transferred the purchase rights to the properties or the prior owner sold the group of properties.

As a fourth example, an owner of a property 102 (such as raw land or acreage) may have the vision to invest in that specific property. The owner may also maintain, preserve, enhance, or promote particular characteristics of that property. For example, the owner may believe that the property 102 will increase in value because of eventual development near the property 102, such as when the owner believes the property 102 is located near a future highway or airport. The owner may then sell the property 102 to a subsequent owner before developers or others are willing to concede that the eventual development increases the value of the property 102. Later, the property 102 may increase in value because the eventual development occurs or looks more certain. By allowing the prior owner to reserve a residual right in the property 102, the prior owner may receive revenue even after the prior owner sells the property 102 and the value of the property 102 increases.

As a fifth example, school districts or any other identifiable subdivisions may recognize the benefits that they provide to a property 102 or a development 104. They may negotiate with one or multiple property owners to receive a residual right associated with the affected real properties, thereby generating revenue that they otherwise have not received.

As shown in these examples, through the use of residual rights, developers, builders, owners, consultants, and other parties may generate revenue from one or more properties 102 even after the properties 102 are sold or a service is provided. The amount of the fee associated with a residual right could be determined independently and without regard to a calculation of net profits per se, and the determination of if and when the fee is payable could occur based upon a specific, tangible, and/or measurable event. As a result, these parties may have a greater incentive to maximize the quality of the issues under their control, to increase the name recognition of a development 104, or otherwise take steps to benefit a property. Moreover, the residual rights allow these parties to benefit along with the current owners or other people who have interests in the properties when the values of the properties increase, when the marketability of the properties increases, or when the properties or their owners or tenants receive some other benefit.

Part of the above description has described the use of a residual right with respect to residential properties 102. The same or similar technique could be used regarding other types of properties, such as raw or improved land or commercial properties. For example, a famous golfer such as Greg Norman could design a golf course. The golf course's association with Greg Norman could increase the value of the golf course, increase the marketability of the golf course, or otherwise provide a benefit to the owner of the golf course. In this example, the golf course itself could be subject to a reserved residual right entitling the designer to receive a fee in response to certain events. In addition, the properties 102 adjacent to the golf course or all properties 102 in development 104 could be subject to a reserved residual right entitling the designer to receive a fee in response to certain events.

Similarly, a grocery, department, or home improvement store entity or any other large retail establishment (including but not limited to theaters, museums, stadiums, and amusement parks) (an “Anchor”) may decide to anchor a shopping center, mall, or other type area. The traffic generated in the area near these facilities is usually beneficial to other retail establishments by attracting more potential customers, and therefore more retail sales, in the other properties. The Anchor or the entities responsible for securing its decision to locate in the area provide benefits to the adjacent retail properties. The adjacent properties could be subject to a residual right benefiting the Anchor, developer, or other entity responsible for securing the Anchor's decision to locate in the area.

Although FIG. 1 illustrates one example of a property development, various changes may be made to FIG. 1. For example, FIG. 1 has illustrated a residential property development. The residual rights and fees associated therewith may be used with any other type of property, such as residential apartments or other undeveloped, residential, or commercial properties. As a specific example, the residual rights and fees may be used in joint development/marketing campaigns where the development 104 is deemed to be included in a certain area under development (such as when the development 104 is in a “seaside” or “uptown” area being jointly developed). Also, the use of residual rights and fees has been discussed above with respect to developers, owners, and consultants (such as designers and architects). This is for illustration only. The residual rights and fees may be used by any person or entity having the legal authority to establish a residual right and any person or entity designated to receive a fee associated with a residual right, such as builders, planners, equity and debt providers, school districts, cities, and other political subdivisions. In addition, numerous factors may affect the value, future appreciation potential, or marketability of a property and therefore form the basis for a residual right and fee, such as: entitlements associated with a development or property; redevelopment, remodeling or renovation activity associated with a development or property; and owners (current or past), tenants, or mix of tenants associated with a development or property.

FIG. 2 illustrates another example property development according to one embodiment of this disclosure. The property development shown in FIG. 2 is for illustration only. Other property developments may be used without departing from the scope of this disclosure.

The property development 104 shown in FIG. 1 represents a residential housing development. In FIG. 2, one or more properties 202 are located within a building 204, and one or more buildings 204 make up a development 214. As an example, the properties 202 may represent condominiums, the building 204 may represent a condominium building or tower, and one or more condominium buildings 204 may represent a condominium development or complex. In this example, each of the properties 202 represents any amount or portion of a structure. The properties 202 may be associated with one or more improvements 206. The properties 202 are also typically associated with various rights, such as the right to enter the development 214 on which the buildings 204 are located. Interests involving the properties 202 could be transferred, such as when a property 202 is rented, leased, bought, or bought as a timeshare or fractional ownership. The property 202 could represent any residential, commercial, or other type of property. The development 214 may include any number or type of buildings 204, each building 204 may include any number or type of properties 202, and the properties 202 or the buildings 204 may be arranged in the development 214 in any suitable manner. As examples, the development 214 could represent a commercial development containing only commercial buildings 204 and commercial properties 202, a residential development containing only residential buildings 204 and residential properties 202, or a development containing both residential and commercial buildings 204 and properties 202.

In this example, the development 214 includes one or more common improvements 208. The common improvements 208 could, for example, represent amenities such as a swimming pool, common areas, or a gym in the development 214. One or more associated benefits 210 are located near, adjacent to, or otherwise associated with the development 214, and one or more natural features 212 are visible from at least a portion of, near, within, adjacent to, or otherwise associated with the development 214.

As with the property 102 in FIG. 1, many different parties or entities may be associated with a property 202 in one way or another. While current owners and their agents have typically profited from increases in value, future appreciation potential, or marketability of a property 202, many other parties did not profit after the property 202 was sold or after a service was performed and a fee paid, even though their actions benefited the property 202 or its owner. For example, the initial properties 202 may have been sold at a lower price when the development 214 was first constructed to create strong initial sales activity. If a developer successfully increases the name recognition of the development 214, the property 202 may have a higher value, future appreciation potential, or increased marketability. However, the developer typically could not benefit financially from the increased value, future appreciation potential, or marketability of the already-sold property 202.

In the property development 214 of FIG. 2, a developer, builder, owner, operator, consultant, or other party or entity may receive or retain a residual right in one or more of the properties 202. The residual right may be used to collect revenue associated with the properties 202, even after the properties 202 are sold or a consulting service is provided and payment for the service is received. For example, a fee or other form of revenue may be collected in response to one or more specified events. The events could include an interest in a property 202 being transferred, a specified time interval elapsing, or any other suitable event(s). Among other things, this may allow a party or entity to be compensated for the increased value or other benefit received by the property 202 or its owner.

As with the property 102 in FIG. 1, the revenue associated with the residual right may or may not have conditions. For example, the residual right may entitle a party or entity to a fee or other form of revenue if and when the value of the property 202 increases or the property 202 otherwise receives a future benefit. In other examples, a residual right may establish a fee or other form of revenue without any underlying conditions.

The following represents one specific example of how a party or entity may use a residual right to receive revenue associated with a property 202. This is a non-limiting example provided for illustration only. The residual rights could be used in any other suitable situation to generate revenue associated with one or more properties 202.

As an example, the name recognition of a development 214 or the name recognition or reputation associated with an owner (past or present), developer, designer, or operator of the development 214 may increase, thus offering potential benefits to property 202 or its owners. For example, The Residences At The Ritz Carlton or some other well-known company may develop and manage a development 214 and have a strong reputation associated with its name. All future owners of properties 202 in the development 214 may exploit the involvement of The Ritz Carlton or some other entity, and each of these owners may benefit from the public's knowledge that the development 214 and the properties 202 were designed, built, or managed by the well-known company. As a result, the values, appreciation potential, marketability, or prestige of ownership of the properties 202 may increase.

In this example, the well-known company may reserve, or have reserved for their benefit, a residual right in the properties 202 entitling the well-known company to receive revenue in response to certain events. The revenue could take the form of a fee paid each time an interest in a property 202 is transferred or in response to any other or additional triggering events, where the right to the fee is established in a reservation of an interest in the property and thus the payment of the fee is enforceable using typical real property ownership rights enforcement mechanisms and techniques. In this way, the well-known company may continue to receive revenue from the properties 202 or development 214 even after the company sells the properties or development.

Although FIG. 2 illustrates another example of a property development, various changes may be made to FIG. 2. For example, while FIG. 2 has illustrated a condominium complex, the use of residual rights and fees may be supported with any other type of property.

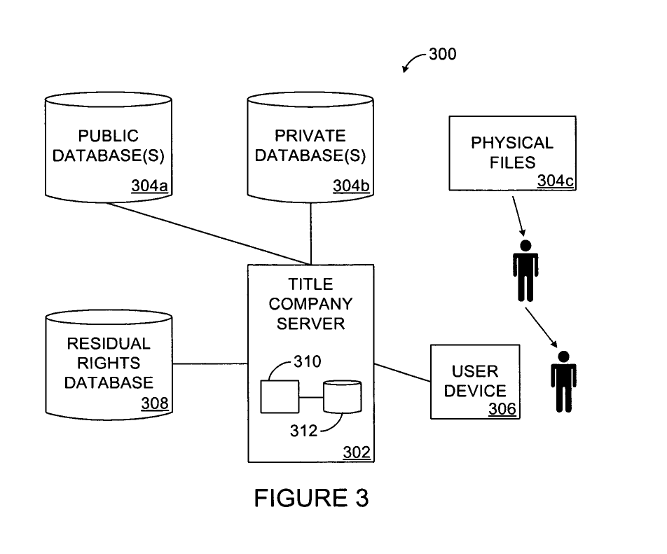

FIG. 3 illustrates an example system 300 for identifying residual rights used for generating revenue from real property according to one embodiment of this disclosure. In this example, the system 300 is used by a title company, attorney, or other applicable party (collectively referred to here as “title company”) and the system 300 facilitates the title company in identifying, implementing, and enforcing the use of residual rights and fees as described above. The system 300 shown in FIG. 3 is for illustration only. Other embodiments of the system 300 may be used without departing from the scope of this disclosure. Also, the use of residual rights and fees may be used in conjunction with any other suitable systems or entities.

As shown in FIG. 3, the system 300 includes a title company server 302, multiple title document sources 304a-304c, and a user device 306. The system 300 may also include a residual rights database 308. The title company server 302 represents a computing device capable of retrieving information related to property, such as a property 102 in FIG. 1 or a property 202 in FIG. 2. For example, a user (such as title company personnel) could provide the title company server 302 with the physical address of a property, and the title company server 302 could retrieve (or be provided, in the case of physical files 304c) information about the property from various data sources. The title company server 302 then provides the collected information to the user for review and/or analysis. As a specific example, the title company server 302 could retrieve title documents from the data sources 304a-304b.

The title company server 302 includes any hardware, software, firmware, or combination thereof for retrieving information related to a property. In particular embodiments, the title company server 302 includes at least one processor 310 and at least one memory 312 capable of storing instructions and data used by the processor 310.

The title document sources 304a-304c represent data sources containing title documents associated with properties. In this example, the title document sources 304a-304c include a public title document source 304a, a private title document source 304b, and a physical title document source 304c. In particular, the public title document source 304a and the private title document source 304b represent electronic databases, while the physical title document source 304c represents a physical, non-electronic source of title documents.

The public title document source 304a represents any suitable public source of title documents, such as an electronic database of records maintained by a county government. The private title document source 304b represents any suitable private source of title documents, such as an electronic database of records maintained by a private company, title company, or group of title companies. The physical title document source 304c represents any suitable public or private source of physical title documents, such as a physical records storage facility maintained by a county government or micro-fiche files maintained by a county government, a private company, or a title company. Appropriate information in the physical title document source 304c may be provided to title company server 302, such as via user device 306.

The public and private title document sources 304a-304b may be accessed electronically by the title company server 302. The title company server 302 then retrieves title documents related to a property based, for example, on the particular physical address of the property. Title documents in the physical title document source 304c may be searched manually. Each of the title document sources 304a-304c represents any suitable source of title documents. While FIG. 3 illustrates the use of three title document sources 304a-304c, the system 300 could include any number and type of title document sources (whether electronic or physical).

The user device 306 allows a user to interact with and control the title company server 302. For example, the user device 306 may allow a user (such as title company personnel) to provide search criteria (such as a property's physical address) to the title company server 302 so that a search for title documents can be performed. Also, the user device 306 allows a user to view the title documents located and retrieved by the title company server 302. The user device 306 includes any hardware, software, firmware, or combination thereof for interacting with the title company server 302. The user device 306 could, for example, represent a desktop computer, laptop computer, terminal, mobile telephone, or personal digital assistant.

In one aspect of operation, personnel of a title company provide search criteria for a property to the title company server 302, and the title company server 302 performs a search to locate title documents related to the property. The located title documents and provided to the user device 306 for review by the title company personnel. A search of physical title documents may also be performed manually, and any located title documents may be input into the title company server 302 are provided to the title company personnel for review. The title company personnel use the located title documents to determine if a title policy or commitment for title insurance should be issued for a transfer of an interest in the property. For example, the title company personnel may use the title documents to determine whether a party attempting to sell a property has a valid interest to sell.

As described above, the property may have an associated residual right establishing a fee that is due upon a transfer of an interest in the property or other triggering event. For example, the seller or buyer of a residential property 102 may be required to pay a fee to the developer of the development 104 because the name recognition of the development 104 has increased the value or marketability of the property 102. The title company personnel use this information from the title documents and specifically from the reservation establishing the residual right to ensure that the fee is calculated, collected at the appropriate time, and provided to the appropriate recipient(s).

The title company personnel may use the foregoing information to require satisfaction of a right to payment under the residual right, preventing completion of a transaction associated with the property until the right/obligation to/of payment is satisfied. Specifically, the title company personnel may ensure that any payments due and owing in association with a residual right associated with the property are paid or are to be paid before issuing a title policy or title insurance. For example, the title company personnel may establish, as a condition of issuing a title policy or title insurance, that the payments with respect to the identified residual right must be brought current as a condition precedent to the title policy or title insurance becoming effective. Such may be accomplished by a closing agent associated with the property transaction collecting the appropriate payment from the transaction proceeds and placing the amount in escrow for the appropriate recipient(s).

The existence of the residual rights and associated fees may be determined using any suitable information. For example, as described above, the residual rights and fees may be established in a deed or other document. In this case, the title company server 302 may retrieve a title document establishing a residual right and fee, or a manual search of the physical title documents may lead to the discovery of a title document containing a residual right and fee. The title company personnel could then identify the residual right and associated fee upon review of the documents.

Instead of or in addition to this, information about residual rights and fees for one or multiple properties may be stored in a residual rights database 308. The residual rights database 308 may store information identifying various residual rights and fees associated with various properties. The residual rights database 308 could also store information identifying conditions associated with the residual rights and fees. For example, a fee may only be due as long as a particular golfer's name is associated with a property. If and when a condition associated with a residual right or fee fails to be met, information identifying this failure may also be stored in the residual rights database 308. This allows, for example, the title company personnel to identify when a particular property or group of properties is no longer, or is not currently, subject to a fee associated with a residual right.

In addition, the database 308 could store information identifying the one or more people or entities that are to receive a residual right fee payment. For example, a residual right could initially be owned by a single party, and the database 308 could identify that party. As time goes on, the residual right could be passed on to that party's heirs or sold to one or more other parties, and the database 308 could identify those heirs or other parties. As a particular example, the database 308 may store information tracking the estates of prior owners of residual rights, allowing the title company to identify a prior owner's heirs who are to receive a residual right payment. The database 308 includes any hardware, software, firmware, or combination thereof for storing and facilitating retrieval of information.

Information in the residual rights database 308 may be provided by a property owner, a residual rights owner, a governmental agency (such as a county clerk), or any other party. The residual rights database 308 may comprise a centralized or distributed database for recording residual rights, and information in the residual rights database 308 may be provided by multiple entities. Accordingly, the residual rights database 308 may comprise a database of residual rights identified with respect to transactions handled by one or more service providers.

Although FIG. 3 illustrates one example of a system 300 for identifying residual rights used for generating revenue from real property, various changes may be made to FIG. 3. For example, FIG. 3 illustrates the use of residual rights and fees in the context of a system 300 used by a title company. The use of residual rights and fees could be used in any other context by any other person or entity, such as a mortgage management company. Also, while the residual right has been described as being specified in a title document, the residual right could be established in another type of document or in any other suitable manner.

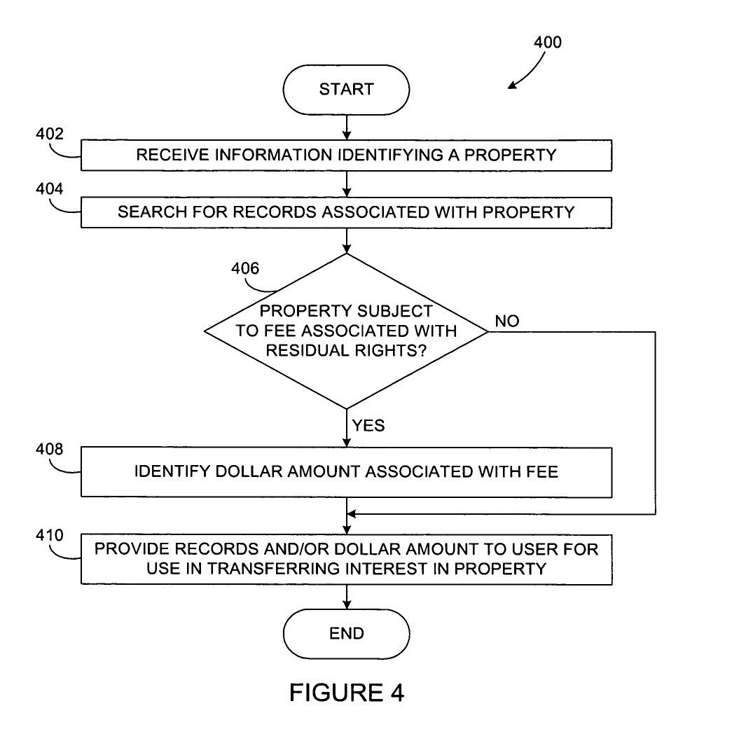

FIG. 4 illustrates an example method 400 for identifying residual rights used for generating revenue from real property according to one embodiment of this disclosure. For ease of explanation, the method 400 is described with respect to the system 300 of FIG. 3 operating to identify a residual right and fee associated with the property 102 of FIG. 1. The method 400 could be used by any other system and for any other property, such as a property 202 in FIG. 2.

The title company server 302 receives information identifying a property at step 402. This may include, for example, the title company server 302 receiving the physical address of a property 102 from a user. The title company server 302 could receive the physical address or other information from the user through the user device 306 or in any other suitable manner.

The title company server 302 searches for data records associated with the identified property at step 404. This may include, for example, the title company server 302 searching any electronic data sources 304a-304b for title documents associated with the identified property. Additionally or alternatively, a manual search of physical title documents, such as contained within physical files 304c, may be performed. Information discovered through any manual search may be provided (such as via user device 306) to the title company, to update residual rights database 308, to provide analysis and reporting by title company server 302, and/or the like. Among other things, the title documents could identify recorded exceptions to title affecting the property 102.

The title company determines, such as by a user accessing and/or analyzing information provided by title company server 302, whether the identified property is subject to a fee associated with a residual right at step 406. This may include, for example, the title company server 302 retrieving information from the residual rights database 308 indicating whether or not the identified property 102 is associated with a residual right. This may also include the title company server 302 retrieving information from the residual rights database 308 indicating whether or not any conditions associated with a residual right have been met.

If a fee is owed, the title company server 302 identifies a dollar amount associated with the fee at step 408. This may include, for example, the title company server 302 identifying a fixed dollar amount or performing calculations to determine the dollar amount owed for a variable fee (such as a fee that increases each year or a fee based on a percentage of a sale price). The title company server 302 provides the retrieved records associated with the identified property and any dollar amount for a residual right fee to a user at step 410. This may include, for example, the title company server 302 providing copies of the retrieved title documents and any dollar amount to a user device 306. The user may use the information from the title company server 302 in any suitable manner, such as to determine whether to issue title insurance for a particular transfer of interest and to ensure that the residual right fee is collected and provided to the appropriate recipient(s).

Although FIG. 4 illustrates one example of a method for identifying residual rights used for generating revenue from real property, various changes may be made to FIG. 4. For example, FIG. 4 illustrates the title company server 302 determining whether a property 102 is subject to a residual right fee and determining the dollar amount of any fee. In other embodiments, the title company server 302 may operate to determine whether a property 102 is subject to a residual right fee without determining the dollar amount of any fee. In yet other embodiments, the title company server 302 could provide any information associated with a residual right fee (such as a title document establishing the fee) to a user, and the user determines if a fee is owed and in what amount.

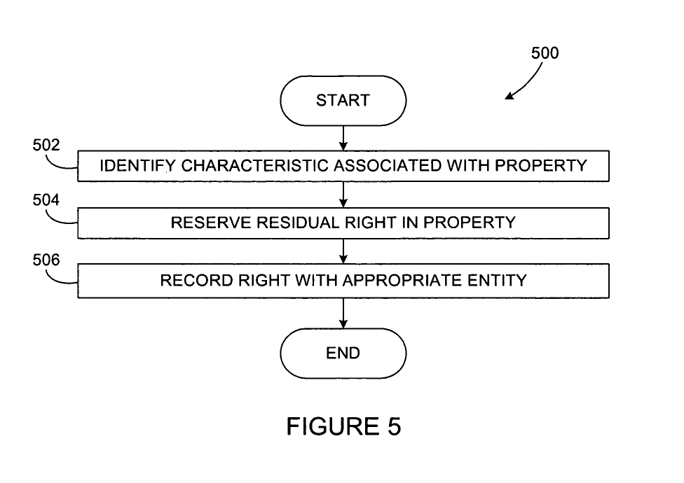

FIG. 5 illustrates an example method 500 for reserving a residual right associated with a property according to one embodiment of this disclosure. For ease of explanation, the method 500 is described with respect to establishing a residual right and fee associated with the property 102 of FIG. 1. The method 500 could be used for any other property, such as a property 202 in FIG. 2.

One or more characteristics of the property 102 are identified at step 502. This may include, for example, identifying one or more characteristics that may provide a benefit to the property 102 at any time (whether immediately or in the future). As a particular example, this may include determining that the name recognition of a development 104, a developer, or a designer may provide a benefit to the property 102. This may also include determining that some feature of the property 102 or the surrounding area might provide a benefit to the property 102.

A reservation document establishing the residual right is executed by the appropriate parties at step 504. This may include, for example, specifying the residual right, a fee associated with the residual right, the party or parties retaining the residual right, and/or to whom fees are to be paid in a title document (such as a deed). This may also include specifying the event or events that would trigger payment of the fee and how the fee is calculated. This may further include specifying how the fee is to be paid, such as by specifying where the fee is to be sent. The residual right may be based on the one or more characteristics identified at step 502. The residual right may be reserved in any suitable manner, such as by granting or retaining the residual right in any appropriate title document or ownership certificate.

The residual right is recorded with the appropriate entity at step 506. This may include, for example, recording the title document or ownership certificate granting or retaining the residual right with a county government.

Although FIG. 5 illustrates one example of a method 500 for reserving a residual right associated with a property, various changes may be made to FIG. 5. For example, multiple residual rights could be associated with a single property. This may occur, for example, if the property benefits from being located in a development 104 with high name recognition and in addition was designed by a famous designer. Also, as noted above, a residual right could be specified without reference to any underlying conditions. In addition, step 502 may be omitted, and the residual right reserved at step 504 need not be based on any identifiable characteristics.

The above description has repeatedly used different terms to describe various parties associated with a property, such as owner, developer, builder, designer, and consultant. These terms are not mutually exclusive, and a single party could fall under multiple ones of these terms. For example, a developer of a development could own a particular property in the development for a time and thus also be an owner. Similarly, a builder could also represent an owner of a property or a designer of an improvement or amenity.

In some, embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method, comprising:
establishing a residual right associated with a real property; and
at a later time, receiving revenue associated with the residual right.

2. The method of claim 1, further comprising preventing any additional residual rights from being reserved in the real property.

3. The method of claim 1, wherein establishing the residual right comprises reserving the residual right upon a transfer of the real property.

4. The method of claim 1, wherein receiving the revenue comprises receiving the revenue in response to a triggering event.

5. The method of claim 4, wherein the triggering event comprises a transfer of an interest involving the real property.
